(19) United States
(12) Patent Application Publication
(10) Pub. No.: US 2004/0068925 A1
(43) Pub. Date: Apr. 15, 2004

(54) Modular plant support system

(76) Inventor: August Puspurs, St-Laurent (CA)

Correspondence Address: INVENTARIUM, SUITE 1607, 4050 Rosemont Blvd., Montreal, QC, H1X 1M4, CA

(21) Appl. No.: 10/619,527

(22) Filed: Jul. 15, 2003

Related U.S. Application Data
(60) Provisional application No. 60/395,994, filed on Jul. 16, 2002.

(51) Int. Cl. A01G 17/06; A01G 17/14

(52) U.S. Cl. 47/45

(57) ABSTRACT

A modular plant support system comprised of a modular stake having three elements: a tip, a rod and a connector and the manner by which these three basic elements cooperate allows for quasi infinite combinations and permutations of shapes and structures.

### BACKGROUND OF THE INVENTION

1. Field of the Invention

The present invention relates generally to staking devices used for supporting plants or sheltering them against snow or other adverse conditions and, more particularly, to a type of turf staking device which is capable of being secured in a laterally extending fashion by the interlocking of several relatively identical discrete components to form an elaborate structure from which plants can be attached to.

2. Description of the Prior Art

Staking devices used for supporting plants are well known in the art and run from the most basic use of sticks or posts to more elaborate structures of cross beams, horizontal ropes or strings between posts to tie down plants.

Amongst the various prior art of record are U.S. Pat. Nos. 5,881,495 by Clark, 4,922,653 by Stone and 3,638,814 by Lowery. These patents describe networks of interconnecting pipes or sticks that form structures. These structures can also be used as conduits for water, thus serving as watering devices as well as supporting devices.

More specifically, patent 495 describes a turf stake onto which can be secured simple two dimensional structures very much similar to plumbing pipes, which makes sense since water is meant to run through the structure. The stakes can also serve as support for a variety of accessories such as a can holder or even an arrows holder.

Patent 653 describes a three dimensional structure also meant for watering but which provides complete surrounding of the plant. A liquid poured in at least one of the stakes can run through the pipes to other stakes and into the soil.

Patent 814 describes flexible crossmembers that can be bent into a variety of shapes to surround a plant.

However, none of the prior art provides for the flexibility of construction of the present invention.

### SUMMARY OF THE INVENTION

It is therefore an object of the present invention to provide a plant support system which is adapted for ensuring substantial peripheral support of the plant.

It is also an object of the present invention to provide a plant support system having modular sections that are easily adaptable for accommodating generally all plant sizes, vertically as well as horizontally.

It is another object of the present invention to provide a framework around which sheets of covering material can be securedly attached as a way to shelter the plants against the elements.

It is a further object of the present invention to provide a plant support system that is economical, versatile and practical even with all its advantages and possibilities.

In order to achieve this, the invention is comprised of a modular stake comprised of three elements: a tip, a rod and a connector and the manner by which these three basic elements cooperate allows for quasi infinite combinations and permutations of shapes and structures.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

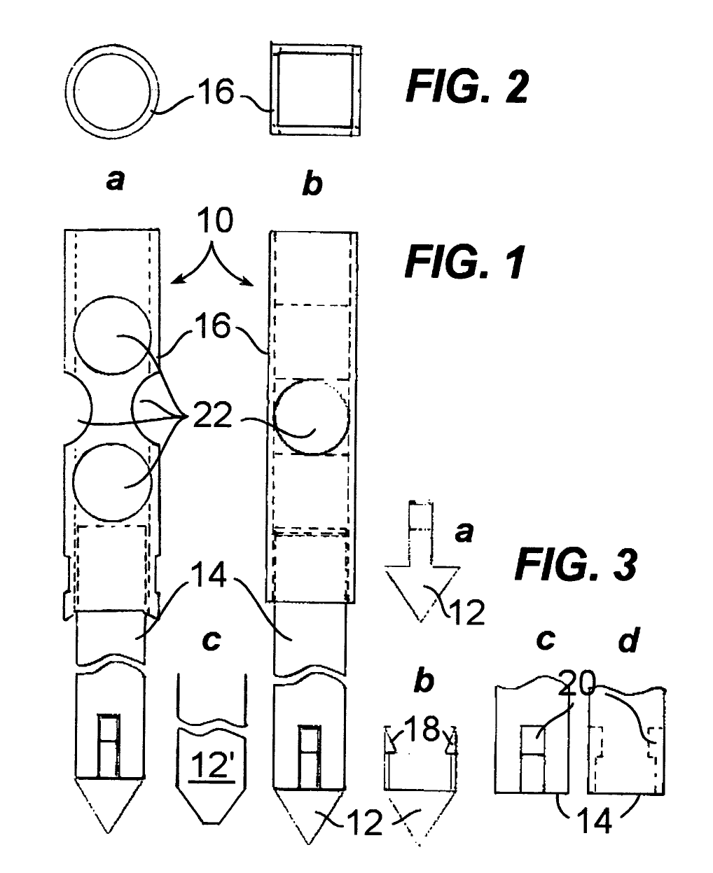

FIGS. 1a, b illustrate 2 side elevations of the modular plant support system.

FIG. 1c illustrates a side elevation of an alternate tip.

FIGS. 2a, b illustrate top views of the stakes and the connectors.

FIGS. 3a-d illustrate two side elevations of the tip and two side elevations of the lower part of the stake into which the tip is inserted.

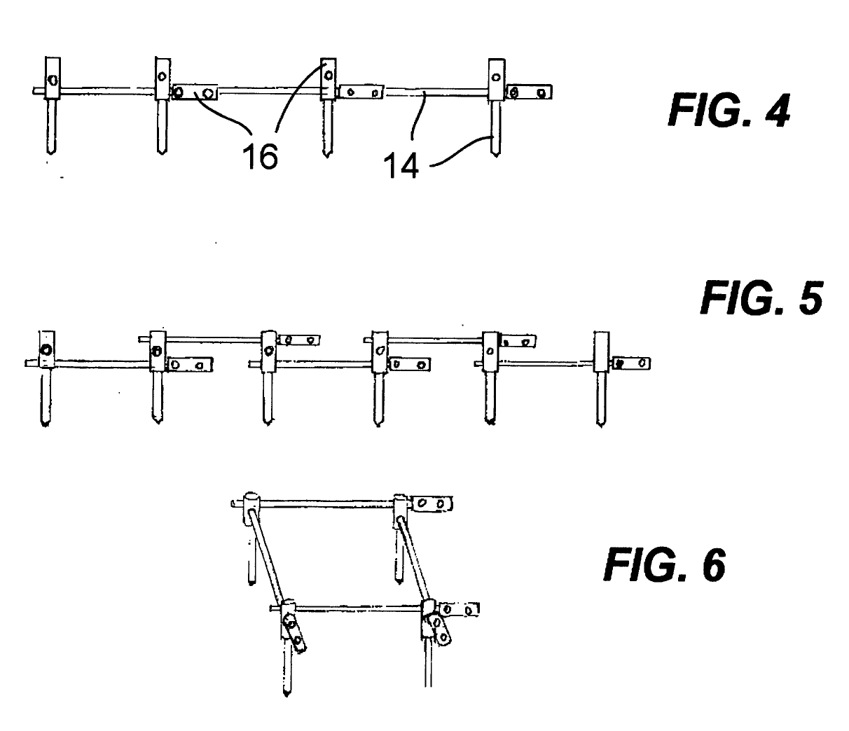

FIG. 4 shows a side elevation of a longitudinal arrangement of the stakes.

FIG. 5 shows an alternate side elevation of a longitudinal arrangement of the stakes.

FIG. 6 shows a perspective view of a three dimensional arrangement of the stakes.

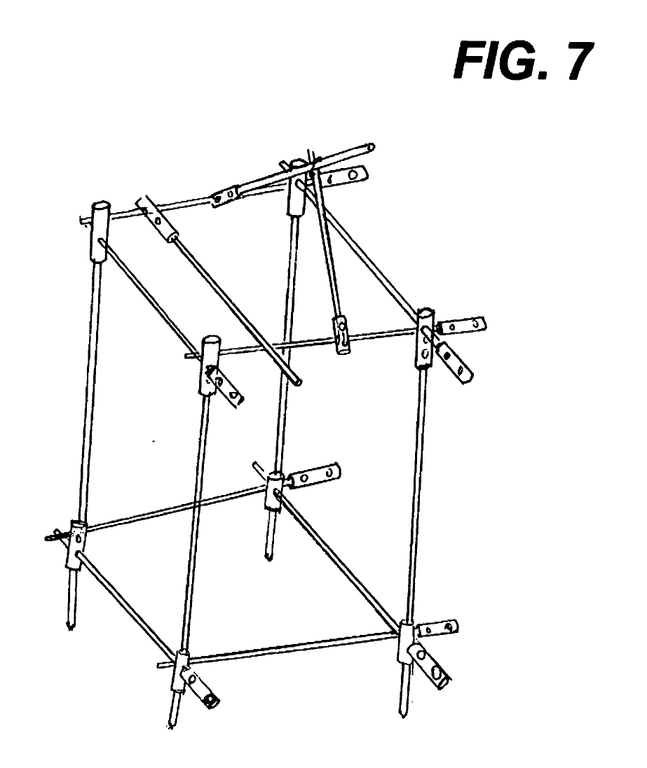

FIG. 7 is a perspective view showing longer stakes set in a vertical arrangement as well as a crisscrossing “roof” arrangement.

### DETAILED DESCRIPTION OF THE PREFERRED EMBODIMENT

A modular plant support system 10 as viewed in FIGS. 1ab is comprised of a separate tip 12, a stake 14 and a connector section 16. The modular plant support system 10 could have a round stake 14 as per FIG. 1a or a square stake 14 as per FIG. 1b.

FIGS. 3ab show two side elevations of the generally conically shaped tip 12, although it could be triangular in shape without departing from the scope of the invention and which releasably connects to the lower end of the stake 14. Any one of several means can be used for connecting the tip 12 with the stake 14 without departing from the scope of the invention. One means is by way of two generally arrow shaped clips 18 which engage suitably configured and sized notches 20 hollowed out into the stake 14. Alternatively, an integrated tip 12′ can be formed integrally from the stake 14 itself as in FIG. 1c.

The stakes 14, which come in different lengths are topped by a connector section 16, which is generally but not necessarily fixedly attached to the stake 14. The connector 16 and the stake 14 could be releasably attached using various means known in the art without departing from the scope of the present invention.

The connector section 16 is hollow and allows for additional stakes 14 to be inserted into its top as per FIGS. 4 through 7 and has a plurality of aligned holes 22 grouped in pairs, also for inserting other stakes 14 therethrough. By using these two methods of insertion, one can build a variety of structures. The stakes 14 can be inserted end to end as per FIG. 4 or staggered as per FIG. 5 or to form square or rectangular shapes as per FIG. 6. They can also be stacked vertically as per FIG. 7 so that they can produce a vertical structure. It should be noted that the stakes can come in different lengths. Also when two sticks are crisscrossed and tied together by a tying means, they can create a roof like structure as shown in FIG. 7, this can be practical for protecting bushes in the winter time by first creating a structure around the bush and then wrapping the structure in burlap or any other such material for that purpose.

1. A modular plant support system for plants comprising:
a tip, a stake and a connector section and holes;
said connector section being generally but not necessarily fixedly attached to said stake;
said connector section being hollow and having holes to allow a stake to be inserted into the top of said connector and through said holes in order to construct a structure.

2. A modular plant support system for plants as in claim 1 comprising:
a separate tip which is releasably connected to said stake by a releasably connecting means.

3. A modular plant support system for plants as in claim 1 whereas:
said holes are being paired.

4. A modular plant support system for plants as in claim 2 comprising:
a tip releasable means consisting of two generally arrow shaped clips which engage suitably configured and sized notches hollowed out into said stake.

5. A modular plant support system for plants as in claim 1 comprising:
stakes having different lengths.

6. A modular plant support system for plants having the following method of assembly:
said stakes inserted through said top and said holes of said connector section in order to build a structure.

7. A modular plant support system for plants as in claim 1 comprising:
stakes and connectors that are round in shape.

8. A modular plant support system for plants as in claim 1 comprising:
stakes and connectors that are square in shape.
